(19) United States
(12) Patent Application Publication
(10) Pub. No.: US 2003/0133071 A1
(43) Pub. Date: Jul. 17, 2003

(54) Assembly structure of rimless spectacles

(76) Inventor: Kwang Hoon Ahn, Taegu (KR)

Correspondence Address: MARTINE & PENILLA, LLP, 710 LAKEWAY DRIVE, SUITE 170, SUNNYVALE, CA, 94085, US

(21) Appl. No.: 10/203,362

(22) PCT Filed: Oct. 25, 2001
(86) PCT No.: PCT/KR01/01809

(30) Foreign Application Priority Data
Dec. 8, 2000 (KR) 2000/34391 U
Dec. 8, 2000 (KR) 2000/34393 U
Oct. 10, 2001 (KR) 20001/62374

(51) Int. Cl. G02C 1/00; G02C 1/02

(52) U.S. Cl. 351/110

(57) ABSTRACT

The present invention relates to an assembly structure of rimless spectacles improving the assembly structure between the interconnecting part that connects a pair of spectacle lens and a connecting part of the bows of a pair of spectacles, more particularly to an improvement for both the structure of a bolt used as an assembly means and the fixing structure of the bolt, its connecting part and a connecting part of the bows of a pair of spectacles, thereby obtaining the effects of increased productivity, minimized defective rate of the products, and the reduced cost of production, etc.

### TECHINCAL FIELD

The present invention relates to an assembly structure of spectacles widely used by the general public, especially to an assembly structure of rimless spectacles that enables to obtain effects including increased productivity, reduced manufacturing unit price, and minimized rate of defective goods during a manufacturing process by improving and simplifying, commonly known as an assembly structure of rimless spectacles, which does not have lens assembly rim.

### BACKGROUND ART

At present there are various kinds of commercially produced goods of spectacles such as sunglasses for drivers, magnifying glasses, and fashion glasses other than supplementary glasses for one's eyesight. These various kinds of spectacles have become fashionable gradually and recently lightweighted rimless spectacles are widely used, and it is almost impossible to feel the weight of them when wearing.

As illustrated in FIG. 1, the rimless spectacles were comprised to assemble as two bolts(3) and nut(4) that fix and fit temple rim connector(1), which is connected with the rim of temples of a pair of spectacles (not illustrated), and the lens(2) in a connector(1) at a prescribed space. In the above conventional assembly structure of rimless spectacles, there were not only difficult points of a manufacturing process in fixing two bolts(3) using welding method on a subminiaturelly manufactured connector(1) in order to make themselves lightweight to the utmost, but also the assembled lens(2) therein, there were some difficult points in the process of the work that a pair of fix holes(5), which exactly accords with the above pair of bolts(3), should bore through. During the process of the work, lens(2) damage has frequently occurred and it has caused to increase the price, therefore, it needed to secure enough space between each fix hole(5) as a means of minimizing the damage rate of lens of high fragility and as a result, it brought out problems since the connector(1) became an obstacle factor of sight. These problems were happening equally in a nose bow connector(6) that is situated between both lenses(2) as illustrated in FIG. 2, connecting and assembling lens(2). To settle the problems of the conventional assembly structure to some extent, two hole assembling methods of improved plans have been drawn up as follows; As illustrated in FIG. 2, after fixing and fitting each one piece of fix bolt(3) in both sides of the nose bow connector(6), and inserting and attaching to the fix hole(5) of singular number that bore through spectacle lens(3) of the subject of an assembly and assemble it as the nut(4), and at the same time, forming lens backing(8) between nose support(7), which is fixed and fitted in the above nose bow connector(6), and nose bow connector(6) for contacting and supporting from the edge of lens(2). But this also brought out difficult points in the process of the work that a distance between the edge of the lens(3) of the subject of assembly and fix bolt(3) over nose bow connector(1), and a distance between a fix hole(5) that passes through lens(3) and lens backing(8) over nose bow connector(6) should be exactly met mutually, and accordingly, it could not eliminate increased rate of defective goods and decline of productivity.

The above-mentioned problems of assembly method equally happened in temple rim connector(1) illustrated in FIG. 1.

### DETAILED DESCRIPTION OF THE INVENTION

This present invention was studied and developed to settle effectively the above problems of an assembly structure of the conventional rimless spectacles, and the technical tasks of this invention are the effects of simplifying the assembly structure and minimizing the rate of defective goods in the process of assembly, and accordingly, increased productivity and reduced manufacturing price at the same time by providing simple plans for being capable of assembling with one hole assembly method, between temple rim connector, nose bow connector and spectacle lens assembled to them, improving the structure of bolt used as a means of assembly.

### BRIEF DESCRIPTION OF DRAWINGS

FIG. 1 is a reference view illustrated an assembly structure between lens and temple rim connector in an assembly structure of conventional rimless spectacles.

FIG. 2 is a reference view illustrated an assembly structure between both lenses and nose temple connector in an assembly structure of conventional rimless spectacles.

FIG. 3 is the 1^{st} execution of illustration view indicating an assembly structure between the temple rim connector and the lens in this invention.

FIG. 4 is the 1^{st} execution of illustration view indicating an assembly structure between both lenses and the nose bow connector in this invention.

FIG. 5 is a reference lateral view extracting and indicating the structure of bolt applied in FIG. 3 and FIG. 4.

FIG. 6 is the 2^{nd} execution of illustration view indicating an assembly structure between temple rim connector and lens in this invention.

FIG. 7 is the 2^{nd} execution of illustration view indicating an assembly structure between both lenses and nose bow connector in this invention.

FIG. 8 is a reference lateral view extracting and indicating the structure of bolt applied in FIG. 6 and FIG. 7.

FIG. 9 is the 3^{rd} execution of disintegration lateral view indicating an assembly structure between temple rim connector & nose bow connector and lens in this invention.

FIG. 10 is the 4^{th} execution of disintegration lateral view indicating an assembly structure between temple rim connector and lens in this invention.

FIG. 11 is partially extracted reference cross-sectional view indicating assembled condition of temple rim connector and nose bow connector to a lens through the 4^{th} execution example of this invention shown in FIG. 10.

FIG. 12 is the 5^{th} execution illustration view indicating an assembly structure between temple rim connector and lens in this invention.

FIG. 13 is the 5^{th} execution illustration view indicating an assembly structure between both lenses and nose bow connector in this invention.

FIG. 14 is an extracted lateral view indicating the external appearance of bolt applied in FIG. 12 and FIG. 13.

FIG. 15 is the 6^{th} execution illustration view indicating an assembly structure between temple rim connector and lens in this invention.

FIG. 16 is the 6^{th} execution illustration view indicating an assembly structure between both lenses and nose bow connector in this invention.

FIG. 17 is the 7^{th} execution illustration view indicating an assembly structure between temple rim connector and lens in this invention.

FIG. 18 is the 7^{th} execution illustration view indicating an assembly structure between lens and nose bow connector in this invention.

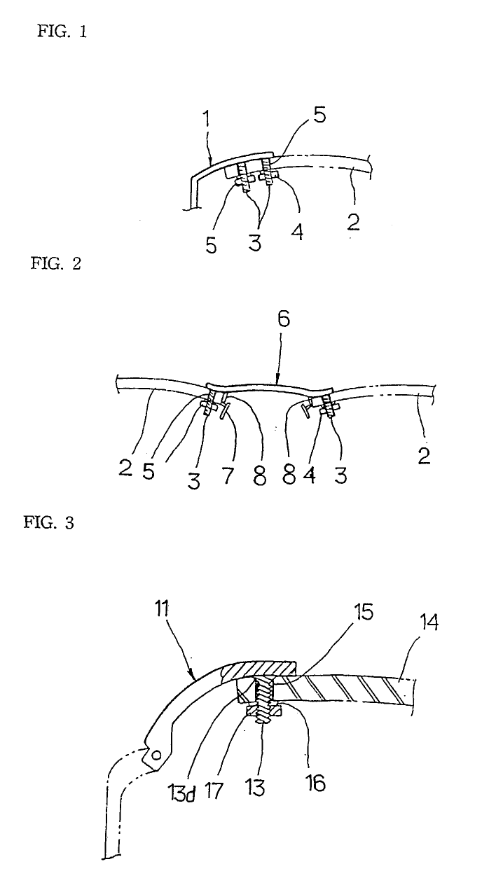

### BEST MODE FOR CARRYING OUT THE INVENTION

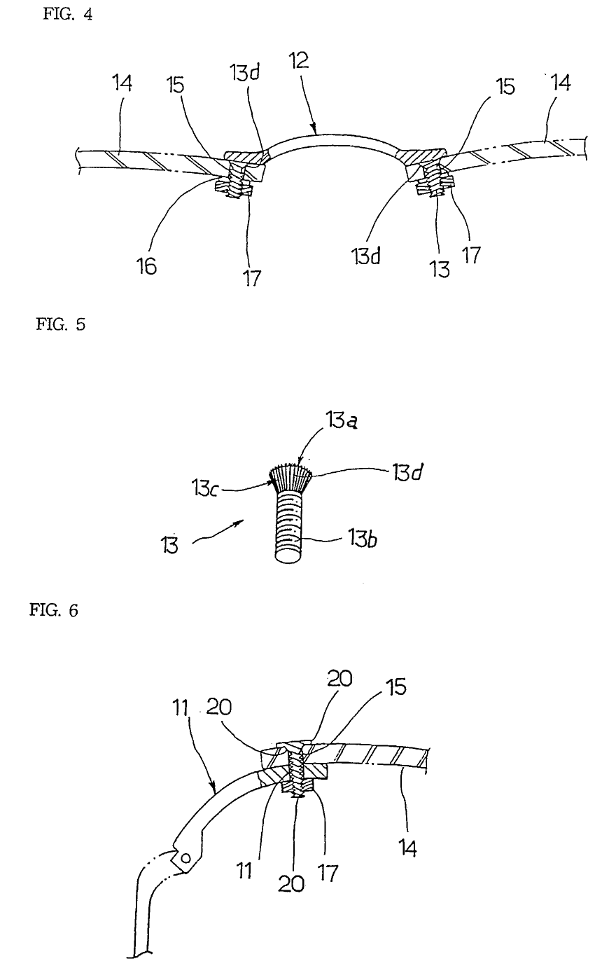

From FIG. 3 to FIG. 5 indicate the 1^{st} execution example of this invention, forming the wide top and narrow bottom incline(13c) between the head(13a) and the screw(13b) of the fix bolt(13) fixed and fitted within the temple rim connector(11) and nose bow connector(12) and at the same time the outer part of the above incline(13c) is comprised of sharp saw-toothed wrinkles unevenly.

The 1^{st} execution example of this invention is made up of this composition as illustrated in FIG. 3 to FIG. 5, and while inserting singular number of fix hole(15) that passes through a lens(14) into the screw(13b) of a fix bolt(13), an assembly process is completed through simple process of screwing the nut(17) after combining the packing(16) and the nut(17)with the screw(13b) in order, and at this moment, as the nut(17) goes on screwing while the outer part of the fix hole(15) of lens(14) that has the same inside diameter with the diameter of the screw(13b) of the fix bolt(13) contacting with the incline(13c) of the fix bolt(13) formed wide top and narrow bottom, it has effects on fixing the lens(14) as the part of the wrinkles(13d) formed sharp saw-toothed unevenly digs into the outer part of the fixture(15).

The above 1^{st} execution example of this invention fixes and fits only the fix bolt(13) of singular number of an assembly location of the temple rim connector(11) and the nose bow connector(12) and at the same time, this enables mutual assembly with one hole assembly method through simple process, penetrating only one fix hole(15) corresponding to the above fix bolt(13) for the lens(4) to be assembled.

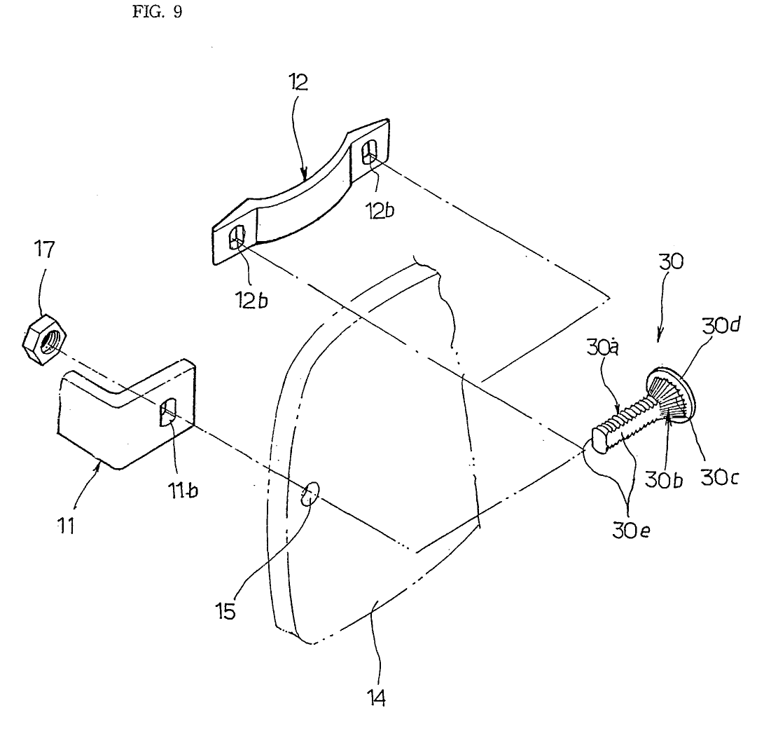

FIG. 6 to FIG. 8 are illustrated the 2^{nd} execution example of this invention, which is supposed to be applied when assembling the lens(14) from the outer part of the temple rim connector(11) and the nose bow connector(12), forming the incline(20b) of the wide top and the narrow bottom at the upper screw of the fix bolt(20) that is accorded with and inserted into the insert holes(11a, 12a) that are penetrated into each of the temple rim connector(11) and nose bow connector(12), the same time, the saw-toothed shape of wrinkles(20c) is formed at the outer space of the above incline(20b), meanwhile, the head whose diameter is somewhat big is formed and comprised at the upper part of the incline(20b).

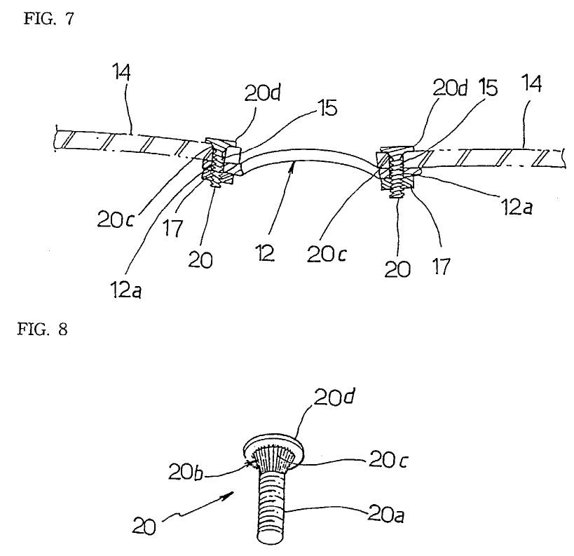

The 2^{nd} execution example of this invention comprised of the above as illustrated in FIG. 6 and FIG. 7, the temple rim connector(11), nose bow connector(12) and lens(14) are enabled to assembly and fix mutually through simple process of clamping and screwing the screw(20a) and the nut(17) after inserting the fix bolt(20)into each fix hole(15) and insert holes(11a, 12a) to be fixed into them, situating the lens(14), through which the fix hole(15) is penetrated at a suitable position, at the outside of the temple rim connector(11) and nose bow connector(12) that are subject of assembly.

The same time, while the outer part of the inside diameter of the fix hole(15) of the lens(14), which has the same inside diameter with the screw's diameter of the fix bolt(20), is contacting with the incline(20b) of the wide top and narrow bottom shape, it makes the nut(17) go on screwing and as the part of the unevenly saw-toothed shape of the wrinkles(20c) of the incline(20b) digs into the outer part of the inside diameter, this makes the lens(14) fix and has an effect on the rigid state of lens fix while the head(20d) of the upper part of the fix bolt(20) is being contacted and supported.

The 2^{nd} execution example of this invention is also for the sake of easy and fast assembly of rimless spectacles with one hole assembly method and its effect is just about the same as the 1^{st} execution example of this invention.

FIG. 9 shows the 3^{rd} execution example of this invention that somewhat modified the 2^{nd} execution example of this invention, the wrinkle(30c) cut the part of both sides of the screw(30a) of the fix bolt(30) that has the head(30d) of which diameter is somewhat bigger than the incline(30b) and the incline(30b) is formed at the outer space, and form the surface(30e), and at the temple rim connector(11) or nose bow connector(12) where lens(14) is assembled, the insert holes(11b, 12b) are penetrated and comprised, which have the same shape with the screw(30a) of the above fix bolt(30).

The 3^{rd} execution example of this invention enables an assembly process to complete quickly through simple process of screwing nut(17) after inserting the screw(30a) of the fix bolt(30) as the state of equally fitting into the fix hole(15) penetrated into the lens(14), and the temple rim connector(11), or the insert holes(11b, 12b) penetrated into the nose bow connector(12), and the action of lens(14) being fixed and assembled as wrinkles formed at the incline(30b) that digs into the inside diameter of the outer part of the fix hole(15)that is the same as the above mentioned 1^{st} and 2^{nd} execution examples, and because the surface(30e) is provided for the screw(30a) of the fix bolt(30) and closely fixed into each insert holes(11b, 12b) it completely eliminates the concern about vain turning of the fix bolt(30) by clamping power when clamping the nut(17), therefore, it has an incidental effect on realizing the assembly work more smoothly.

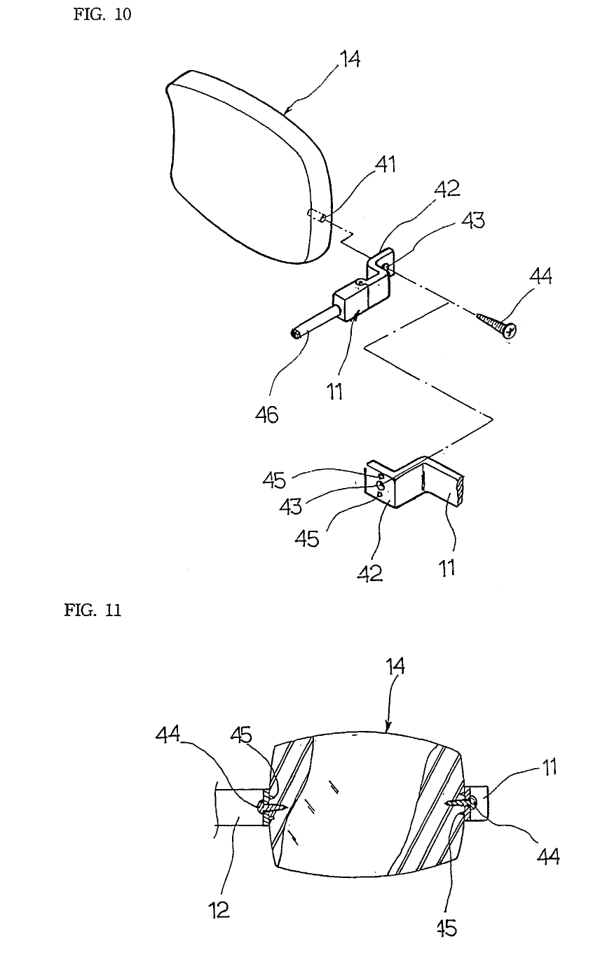

FIG. 10 and FIG. 11 show the 4^{th} execution example of this invention, the rimless spectacles in which the temple rim connector(11), nose bow connector(12) and a pair of spectacle lenses(14) are mutually assembled and comprised, while one fix hole(41) is formed at an adequate lateral part of the spectacle lens(14), and the contact(42) that is contacted with the part of the above fix hole(41) is formed at the temple rim connector(11) and the nose bow connector(12), it enables screw(44) clamping by penetrating the screw hole(43), and by forming sharply pointed-end fix projection(45) at the upper or lower part of the above screw hole(43), the above fixed projection(45) digs into the lateral part of the spectacle lens(14) and rigidly assembles when clamping the screw(44) with the screw hole(43) of each connector and the fix hole(41) of the spectacle lens(14).

Unexplained number 46 indicates spectacle temple rim.

This device thus constituted enables to complete the assembly process of the spectacles through the simple process of clamping and screwing one screw(44) with the fix hole(41) of the spectacle lens(14) and the screw hole(43) of each connector under the state of direct contacting the lateral part of the spectacle lens(14) with temple rim connector(11) and nose bow connector(12), and the same time, the fixed projection(45) of the contact(42) provided for each connector(11, 12) digs into the lateral part of the spectacle lens(14) with the screw(44) and assembles into mutually solid condition. Here, the fixed projection(45) protruded and formed at the contact(42) can be comprised singular or multiple number.

The 4^{th} execution example of this invention as stated above, enables to have an equal effect on minimizing the effective rate in the course of process and increasing productivity as well as on making its own weight ultra lightweight, which is the greatest advantage of rimless spectacles, by forming only one fixture at the lateral part of spectacle lens and penetrating only one screw hole into each connector that is assembled, enabling simple assembly through the screw.

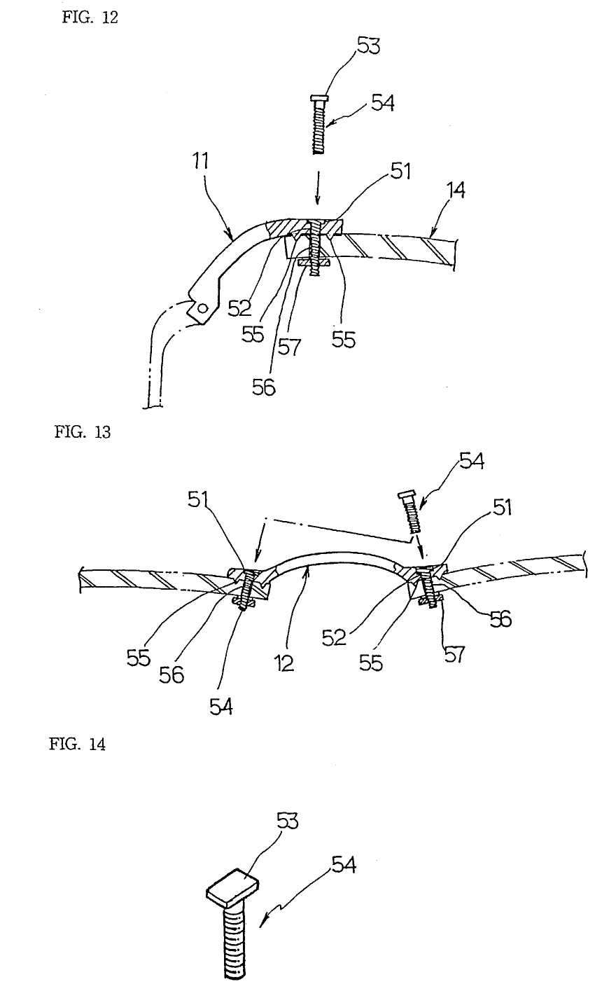

FIG. 12 and FIG. 13 show the 5^{th} execution example of this invention is comprised, while penetrating the bolt(52) dented and formed the counter sink of groove(51) of the head at the top of temple rim connector(11) and nose bow connector(12) and inserting and setting up the bolt(54) that has the head(53) of a rectangular shape, at one side or both sides of the bolt hole(52) that penetrates into each connector(11,12) projects and forms sharp pointed end fix projection(55), a passage hole(56) is penetrated into the lens(14) that is assembled with each connector(11,12), thereby after each connector(11, 12) and the lens(14) are mutually assembled with a bolt(54), an assembly process can be completed through the simple process of clamping and screwing the nut(57). As shown in the 5^{th} execution example of this invention, while screwing the nut(57) that is clamped with the screw part of the bolt(54), the fixed projection(55), which is projected around the screw hole(52) and projected into the inside of the lens(14), digs into the inside of the lens(14) so that it maintains rigid state of assembly without any flow.

FIG. 14 is a lateral view extracting the applied bolt of the 5^{th} execution example of this invention as described above and showing its appearance.

It enables the head(53) of the bolt(54) that has somewhat big area to clamp the bolt(54) smoothly without any vain turning during the screwing of the nut(57) as the nut(57) gets screwed when the part of the head(53) of the bolt(54) is securely attached to the counter sink of groove of the head(51) of the bolt hole(52) that penetrated into each connector(11,12).

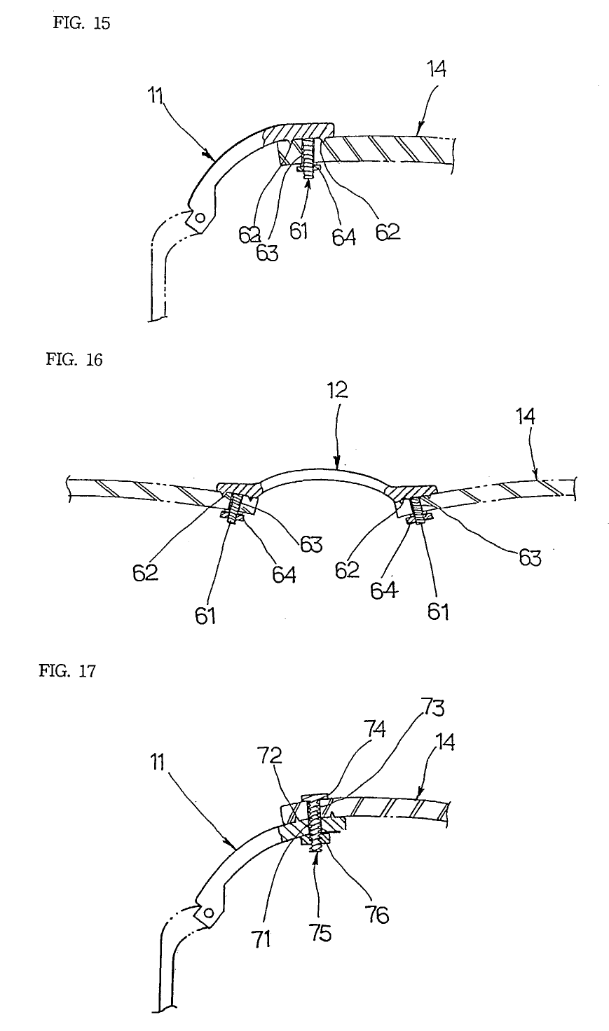

FIG. 15 and FIG. 16 show the 6^{th} execution example of this invention that is somewhat similar to the above 5^{th} execution example,

Wherein the bolt(61) is welded and fixed at the inside part of the temple rim connector(11) and nose bow connector(12) the same time, sharp pointed end fixed projection(62) is projected and formed at the both sides or one side of the above bolt(61), and at the lens(14) that is assembled with it, through the simple process of screwing the nut(64)while inserting the above bolt(61) by penetrating the passage hole(63) into which the above bolt(61) accords and inserts, it is comprised to complete the mutual assembly process of the connector(11,12) and the lens(14), just then it is assembled into a solid state as the fixed projection (62) digs into the lens(14) by the nut's clamping power. The other effects are quite similar to the 5^{th} execution example of this invention as stated above.

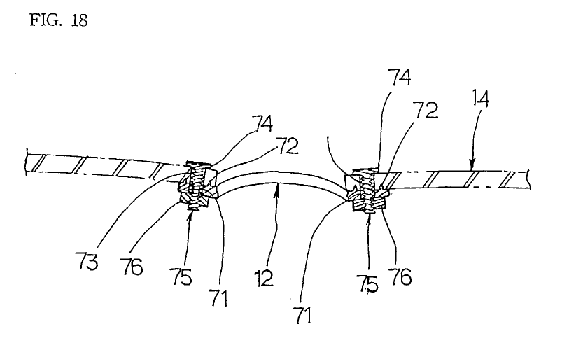

FIG. 17 and FIG. 18 show the 7^{th} execution example of this invention that is somewhat similar to the 5^{th} and 6^{th} execution example of this invention as stated above.

At the same time the bolt hole(71) penetrates into the temple rim connector(11) and the nose bow connector(12), at the lens(14) in which sharp pointed end fixed projection(72) projects and forms at the outside part of the bolt hole(71) and assembles with each connector(11,12), the nut(76) is clamped and completed while a bolt(75), which has the head(74) being penetrated to the passage hole(73) equivalent for the above bolt hole(71), is being inserted into each bolt hole(71) and passage hole(73), this also is assembled into a solid state as the fixed projection(72) digs into the lens(14) by the nut's clamping power same as the 5^{th} and 6^{th} execution example of this invention.

### INDUSTRIAL APPLICABILITY

This invention as stated above is a useful invention in order to increase productivity and reduce cost by simplifying assembly process as well as to minimize defective rate, by improving the structure of the fixed bolt that is used as a means for assembly of rimless spectacles and the assembly structure in accordance with it, thereby enabling one hole assembly method.

1. An assembly structure of rimless spectacles, which mutually assembles temple rim connector(11), nose bow connector(12) and a pair of lenses(14) and completes a pair of spectacles, wherein the mutual assembly between the temple rim connector(11) and lens(14), and the nose bow connector(12) and lens(14)characterized by formation of one hole assembly structure using one fixed bolt.

2. An assembly structure of rimless spectacles according to claim 1, wherein it is one hole assembly method, comprised and characterized by the wide top and narrow bottom shaped incline(13c) is formed between the head(13a) and the screw(13b) of the fixed bolt(13) used as a means of assembly, and the same time, the outer surface the above incline(13c) is formed as uneven wrinkles(13d) and forms the fixed bolt(13), in the meantime, the part of the head of the above fixed bolt(13) is fixed and fitted into the proper inside part of the temple rim connector(11) and the nose bow connector(12), and while inserting and attaching the fix hole(15) that is penetrated into the lens(14) to be assembled to the screw(13b) of the above fixed bolt(13), the nut(17) is clamped and mutually assembled.

3. An assembly structure of rimless spectacles according to claim 1 or claim 2, wherein the structure is comprised and characterized by the head(20c) that has somewhat big diameter forming at the upper part of the incline(20b) of the upper part of the screw(20a) that has the wrinkle(20c), and forms the fixed bolt(20) used as a means of assembly, then while according the insert and attachment holes(11a, 12a) of the temple rim connector(11) and the nose bow connector(12) of the mutual assembly subjects with the lens(14), the nut is clamped with the screw(20a) and mutually assembled.

4. An assembly structure of rimless spectacles according to claim 3, wherein the structure is comprised and characterized by the wrinkle(30c) that forms the surface(30e) at both sides of the screw(30a) of the fixed bolt(30) that has the head(30d) whose diameter is somewhat bigger than the incline(30b) and the above incline(30b) on which the wrinkle(30c) is formed at the outside diameter, and forms the fixed bolt(30) used as a means of assembly, at the temple rim connector(11) and the nose bow connector(12) to be assembled, the insert and attachment holes(11b, 12b) are penetrated, which have the same cross section with that of the above screw(30a), thus the lens(14) by a fixed bolt(30) mutually assembles with the temple rim connector(11), lens(14) and nose bow connector(12).

5. An assembly structure of rimless spectacles according to claim 1, wherein the structure is comprised and characterized by one fix hole(41) that is formed at the side of the spectacle lens(14) and the contact(42) that is attached and supported at the part of the above fix hole(41) is arranged at the temple rim connector(11) and the nose bow connector, the same time the screw hole(43) is penetrated into the above contact(42) thereby the lens(44) assembles with each connector(11,12) by the screw(44), while the fixed projection(45) is projected and formed at the upper and lower part of the screw hole(43) of the above contact(42), the fixed projection(45) digs into the side of the lens(14) by the clamping power when clamping the screw(44).

6. An assembly structure of rimless spectacles according to claim 1, wherein the structure is comprised and characterized by the bolt hole(52) in which the counter sink of groove of the head being dented and formed is penetrated into the temple rim connector(11) and nose bow connector(12) and the bolt(54) that has the square head(53) is inserted and attached, and the fixed projection(55) is projected and formed around each bolt hole(52), a passage hole(56) into which the bolt(54) is inserted and attached is penetrated into the lens(14) that is assembled with each connector(11,12) thereby the connector(11,12) and the lens(14) are assembled with one bolt(54) and the same time, the fixed projection(55) digs into the inside of the lens(14) and assembled by the clamping power when clamping the nut(57).

7. An assembly structure of rimless spectacles according to claim 1, wherein the structure is comprised and characterized by the bolt(61) that is welded and fixed to the interior part of the nose bow connector(12) and the temple rim connector(11), and the same time, the sharp pointed end fix projection (62) projects and forms around the above bolt(61) and at the lens(14) assembled thereto, the passage hole(63) into which the above bolt(61) accords and inserts is penetrated and while inserting the above bolt(61), the nut(64) is clamped and assembled.

8. An assembly structure of rimless spectacles according to claim 1, wherein the structure is comprised and characterized by the bolt(71) that is penetrated into the temple rim connector(11) and the nose bow connector(12) and the same time, the fixed projection(72) is projected and formed at the exterior part of the bolt hole(71), and at each lens(14) penetrating the passage hole(73) corresponding to the above bolt hole(71) and inserting one bolt(75) that has the head(74) into each bolt hole(71) and the passage hole(73), the nut(76) is clamped and assembled.
